(19) United States
(12) Patent Application Publication
(10) Pub. No.: US 2013/0346227 A1
(43) Pub. Date: Dec. 26, 2013

(54) Performance-Based Pricing for Cloud Computing

(71) Applicants: Navendu Jain, Seattle, WA (US); Ishai Menache, Redmond, WA (US)

(72) Inventors: Navendu Jain, Seattle, WA (US); Ishai Menache, Redmond, WA (US)

(73) Assignee: MICROSOFT CORPORATION, Redmond, WA (US)

(21) Appl. No.: 13/530,399

(22) Filed: Jun. 22, 2012

(51) Int. Cl. G06Q 30/00; G06Q 30/08; G06Q 40/00; G06Q 30/02

(52) U.S. Cl. 705/26.3; 705/400; 705/39

(57) ABSTRACT

Described are performance-based pricing models for pricing execution of a client job in a cloud service. Client-provided performance-related parameters are used to determine a price. The price may be a minimum bid price that is evaluated against a bid received from client bidder to accept or reject the bid. Alternatively, the price may be returned as a quote. For batch application-type jobs, performance parameters include a work volume parameter and a deadline or the like. For an interactive-type application job, example performance-related parameters may include an average load parameter, a peak load parameter, an acceptance rate parameter, a minimum capacity parameter, a maximum capacity parameter, and/or a time window parameter over which load is specified.

### BACKGROUND

Enterprises often lease computing resources from cloud computing services, as this is often more economical than purchasing and supporting their own computing resources, particularly when extra computing capacity is only temporarily needed. Most cloud computing services offer different pricing schemes for cloud computing to meet the diverse requirements of end users. While these schemes are simple, each has certain drawbacks.

For instance, on-demand (“pay-as-you-go”) pricing schemes are expensive, particularly for large customers. At the same time, on-demand computing provides no capacity guarantees that the cloud service/provider will be able to satisfy a client's resource needs, particularly when there is large dynamic demand.

Spot pricing is another scheme that provides for lower usage costs because users bid for resources as needed e.g., by the hour, and typically at below the on-demand price. However, job execution may be interrupted when the market spot price exceeds the bid price, whereby there is no certainty as to when a job will complete. There is also no certainty as to what the total execution cost will be, given dynamic market spot price.

Reservation/subscription type schemes provide a model that is closer to in-house hosting than an on-demand cloud service. However, reservation/subscription type schemes can be very inefficient, as resources need to be reserved based upon the highest predicted load, whereby resources are wasted at other times. Such schemes may be suitable when long-term usage is fairly steady and predicted usage is accurate, but this assumption does not hold in many scenarios.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a cloud service prices execution of a job set (one or more jobs) based upon receiving performance-related parameters from a client requestor. In one aspect, the cloud service processes the performance-related parameters to determine a minimum bid price that is evaluated against a bid received from client bidder, and returns a response corresponding to acceptance or rejection of the bid based upon the evaluation. In an alternative, cloud service processes the performance-related parameters to determine a price that is returned as part of a quote, whether binding or not.

For a job comprising a batch-type application, example parameters include a work volume parameter and time data comprising a completion time. For a job set comprising an interactive-type application, example performance-related parameters may include an average load parameter (e.g., number of requests or transactions), a peak load parameter, an acceptance rate parameter, a capacity parameter corresponding to a statistical metric, and/or a time window parameter over which load is specified.

In one aspect, there is described entering into a performance agreement with a client, in which the agreement is to execute a job set in a cloud service according to agreed-upon performance parameters and an agreed upon price. The cloud service attempts to execute the job set according to the agreed-upon performance parameters, and compensates the client in some way if unable to execute the job set according to the agreed-upon performance parameters.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a system that facilitates performance-based pricing models for job execution in a cloud service, according to one example embodiment.

FIG. 2 is a flow diagram representing example steps that may be taken in a bidding scenario to decide whether to accept a client bid based upon a minimum price determined from client-provided performance parameters, according to one example embodiment.

FIG. 3 is a flow diagram representing example steps that may be taken in a price quote scenario to determine a price to return to a client based upon client-provided performance parameters, according to one example embodiment.

FIG. 4 is a block diagram representing an example computing environment into which aspects of the subject matter described herein may be incorporated.

### DETAILED DESCRIPTION

Various aspects of the technology described herein are generally directed towards ‘pay-per-performance’ pricing models for running jobs (interactive-type and/or batch-type applications hosted) in the cloud that facilitate service differentiation by charging customers based upon the performance they desire. The service provides a binding agreement/contract specifying that the hosting cloud will aim to meet the desired performance. The cloud service can schedule resources to meet performance bounds under the performance-based (value-based) pricing models; notwithstanding, the agreement specifies compensating customers if the bounds are violated. Additionally, the process of compensating customers may involve verifying whether the bounds are violated due to cloud-side problems, client-side problems, or other factors.

In one aspect, a client customer specifies parameters (dimensions) related to performance. These different dimensions of performance, such as workload volume (CPU hours needed) and due date/time (a deadline) provide service differentiation levels that correspond to a price. A menu of pricing models may be used to show customers the cost versus benefit tradeoffs, whereby users may optimize their goals.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and pricing schemes in general.

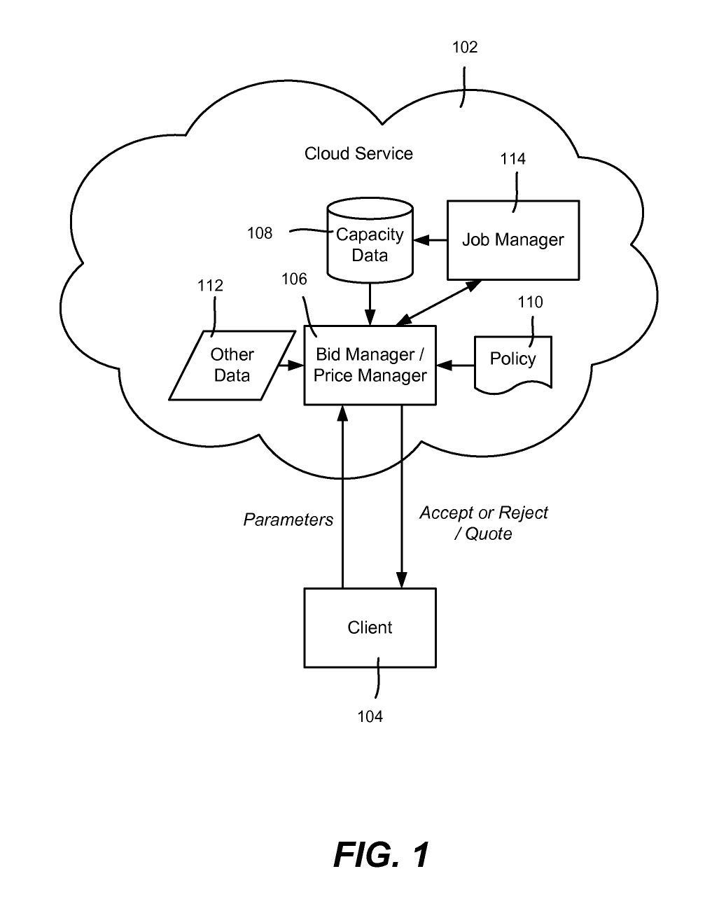

FIG. 1 shows a block diagram comprising an example system for providing performance-based pricing with respect to a cloud service 102. In one implementation, a client 104 submits bid parameters to a bid manager (block 106) comprising software code, configuration, component placement layout or the like that gathers information and performs computations as described herein. Note that as used herein, “client” refers to any entity that interacts with the cloud service, whether or not an agreement is reached. The bid parameters for batch jobs comprise work volume (e.g., an aggregate volume of work, in CPU hours, to be performed), a parallelism bound over time indicating what application processes can run in parallel and at what time, and a deadline for the job set (one or more jobs) to be completed, e.g., a time window comprising the needed turnaround time from when the job or jobs are submitted. In the example implementation of FIG. 1, the client 104 also submits the price to be paid if the job set is accepted.

In an alternative model, instead of having the client 104 provide a price in a bidding scheme, the client 104 may request a price quote along with providing (at least) the volume and deadline parameters, and typically the parallelism parameter. The cloud service (a price manager also represented via block 106) computes and returns a price and an acceptance deadline (e.g., a relatively short timeframe), in which the computation is generally directed towards maximizing total revenue, social welfare (satisfying clients), reducing operating costs, resource utilization and/or the like. Acceptance is then up to the client 104. Although in this model the client 104 may be able to shop around for a better price, possibly providing some advantage to the client 104, the price may increase or even the job being rejected if not accepted in time.

Other, optional parameters may be submitted by the client 104. These include virtual machine type and datacenter information. For example, the client 104 may specify that some class of (e.g., large) virtual machines be used, each with at least 4×1.6 GHz CPU and 7 GB of RAM for example; alternatively, the client may specify actual machine parameters, e.g., minimums for CPU, memory, storage (e.g., disk) and/or network parameters.

The client 104 also may specify a datacenter location for running the job. For example, if the client 104 has data-intensive workloads with a large amount of data to be processed stored at a particular datacenter, the client 104 wants the job set to be run at that datacenter location to avoid a large amount of data transfer time. For compute-intensive workloads where data transfer is not significant, the client 104 need not specify a datacenter, which provides the cloud service 102 with more flexibility and provides the client 104 with fault-tolerance over single-site failures.

Thus, one set of possible parameters is <VM type, Volume of work, Due date, Price, Datacenter>, which (using example values) the client 104 may submit as <‘large’, 20 k CPU hours, 9 pm EST today, $7000, ‘WestCoast> (where ‘large’ represents a VM class, and ‘WestCoast’ represents an example datacenter location. This parameter set defines that 20 k CPU hours on virtual machines of type ‘large’ will be provided to the user's batch job set will complete by 9 pm EST on a datacenter in the west coast region for $7,000. The price may be a bid amount, or a price quote for comparison so the customer can gauge their savings by selecting a desired pricing option.

As can be readily appreciated, other ways of specifying parameters may be used. For example, instead of a deadline, a time window may be provided, e.g., 9 am to 3 pm EST has both a starting time and an ending time. Instead of classes of virtual machines that are fixed labels such as small, medium or large for, a different (e.g., numerically increasing as technology advances) scheme may be used, as what is a ‘large’ virtual machine today may be considered ‘small’ in a year or two. Alternatively, instead of fixed labels, the actual virtual machine resources (CPU, memory, disk, network) may be explicitly specified as parameters.

In a bidding scenario, the bid manager (block 106) takes the parameters as input and uses them in conjunction with additional data to compute an accept or reject response. In a price quote model, the parameters may be used in determining the quote. The additional data may include capacity data 108, which the bid manager accesses to determine whether the cloud has sufficient resources to accept the new job set. The capacity data 108 also may be used to compute the minimum acceptable price or price quote; for example, if resources are running low (but sufficient to handle the job set), the minimum acceptance price or quote may be increased to use those scarce resources only if the client is willing to pay more. Conversely, if resources are plentiful and the job set is likely to complete before another need for those resources is likely, the minimum acceptable bid or price quote may be lowered. Historical data and trend data may be used, for example, to predict the likelihood of maximizing revenue by increasing or decreasing the minimum acceptance bid.

Policy data 110 also may be accessed (or coded into the bid manager/price manager, block 106), such as a minimum acceptable price or price quote for the volume of work and the deadline. Other data 112, such as client-related data may be used in the price computation and/or to select from different pricing schedules in the policy data. For example, by maintaining customer profile data, a client who is a regular customer with a good reputation for payment may have a lower price computed or quoted than a new customer, based upon different pricing schedules and/or one or more variable factors in the price computation. A client who has an overdue bill may get a rejection or not get a price quote, until the bill is paid; such information may be maintained as part of the other data 112. A credit score also may be a factor in pricing. In a bidding scenario, another reason for rejection (or increasing the minimum acceptance price) is taking action to prevent incremental bidding in which the client starts with a low bid and incrementally increases the bid over and over until it is ultimately accepted. For example, when there are too many rejected bids from the same client in a given time period, action in the form of a rejection or a computing an increased minimum price may be taken to avoid such incremental bidding scenarios.

If an acceptance is given to a bidding client, or a price quote accepted by a requesting client, a binding agreement is formed. In this way, both the service 102 and client 104 know what resources will be provided by the service 102, and by what deadline those resources will be used. As long as the client specifies sufficient resources to complete a job set by the deadline, the client knows that the deadline will be met with respect to that job set. (In one model, unused resources may be sold back to the service 102 as part of the agreement, such as at a fraction of the price.) In the event of an inability of the cloud service 102 to meet the terms for which the cloud service is responsible, as part of the agreement, the cloud service 102 provides a guarantee backed by an agreed-upon compensation penalty or the like. For example, the compensation to the client may be in the form of a monetary rebate to the client, future credit, and so forth.

Note that the job parameters also may specify client responsibilities as part of the agreement. For example, the client may agree that the client code needs to be able to process 1 k transactions/minute; however if the client code is unable to do so, (even given sufficient resources from the cloud), the cloud service has a verifiable proof that the client code is problematic and/or that the cloud service has met its own terms, and there is no compensation in such an instance.

In the example of FIG. 1, upon acceptance of a bid or acceptance by the client of a price quote, the bid manager/price manager communicates information about the job set to the job manager 114. In a typical scenario, the job code and the data are already available in the cloud service 102. In the event that the client needs to provide data and/or job code not yet in the cloud can be communicated to the job manager (or another cloud entity), with the client responsible for providing the data and/or job code by an agreed upon time so that the job can be started in time to meet the deadline. Alternatively, the deadline may be relative to when the client provides the data and/or job code.

The performance parameters described above are generally related to batch computing, basically a price for delay-tolerant computing based on the aggregate volume of work to be performed by a specified deadline, (rather than committing to a fixed number of rented virtual machines over time, for example). Overall, this model leverages flexibility on user's part as to when to run their job, while at the same time providing the cloud service with the opportunity to flexibly schedule user jobs based on dynamic demand and operating costs (e.g., electricity), among other factors.

As can be readily appreciated, the more flexibility a client has with respect to timing, the lower the price that the client can expect to have accepted or quoted. Performance-based pricing can be higher or lower than on-demand pricing, for example. Higher prices generally correlate with more utility of guaranteed capacity and strictness in job due date. Lower prices generally correlate to a volume-based discount for delay-tolerant jobs, which the cloud service can move to off-peak periods. This smoothes out what otherwise may be periods of low utilization in which idle capacity is wasted.

The pay-per-performance model described herein also works with one or more interactive applications of a job set. For interactive applications, the performance model (or quality) may be defined as a Service-Level Agreement (SLA), e.g., ninety percent of requests get responses within 300 ms (inside the datacenter) at a peak load of 1,000 requests per second. With this pricing model the customer pays for service quality, instead of a quantity of resources. Given an SLA on desired performance, the pricing model translates this SLA in terms of a dollar cost over a time window such as approximately $1,000 per day, or approximately $25,000 per month. The SLA may be split into components (e.g., inter-component SLAs), which may correspond to a combination of execution time and minimum throughput, e.g., inter-component SLAs as sum of execution times and minimum throughput on the bottleneck component.

This pricing model may be presented as a set of menus specified by the cloud or negotiated between the application owner and the cloud. The different SLA dimensions/parameters may include average load, peak load, acceptance rate (e.g., as a percentage), capacity requirements corresponding to a statistical metric (e.g., maximum load, minimum latency, a median, and/or a percentile or percentiles such as ninety-fifth percentile of latency, and so on), a time window over which load is defined and a penalty on SLA violations.

Note that computation guarantees may be based upon storage and network bandwidth throughput rates. For example, with latency-sensitive and throughput-oriented applications, a performance factor governing their execution times is the rate at which data can be read or written. In particular, a CPU stalling waiting for data to arrive from either a local memory/disk, cluster file system, or the network wastes resources resulting in high execution delays. Therefore, the cloud system may provide per-machine guarantees on the network bandwidth and the storage bandwidth (i.e., BOPS and IOPS), whose cost can be directly incorporated in the pricing models.

These pricing models can be introduced as a menu of pricing choices (incentivizing volume-based usage) or a negotiated or bid price. For example, performance-based pricing may incentivize customers to buy a larger volume of unused cloud resources during off-peak periods. This improves cloud resource utilization during off-peak periods.

Example pricing options include different prices for different CPU hours, such as 20 k CPU hours for $5000, 30 k CPU hours for $7000, 50 k CPU hours for $10,000 and so on, basically providing discounts for bulk purchases. Note that 20 k CPU hours may be accomplished by running 2,000 virtual machines for 10 hours, 5,000 virtual machines for 4 hours, and so forth. Another option is price variation by deadline, e.g., $10,000 by 12 noon, $8,000 by 3 pm, or $1,000 by midnight.

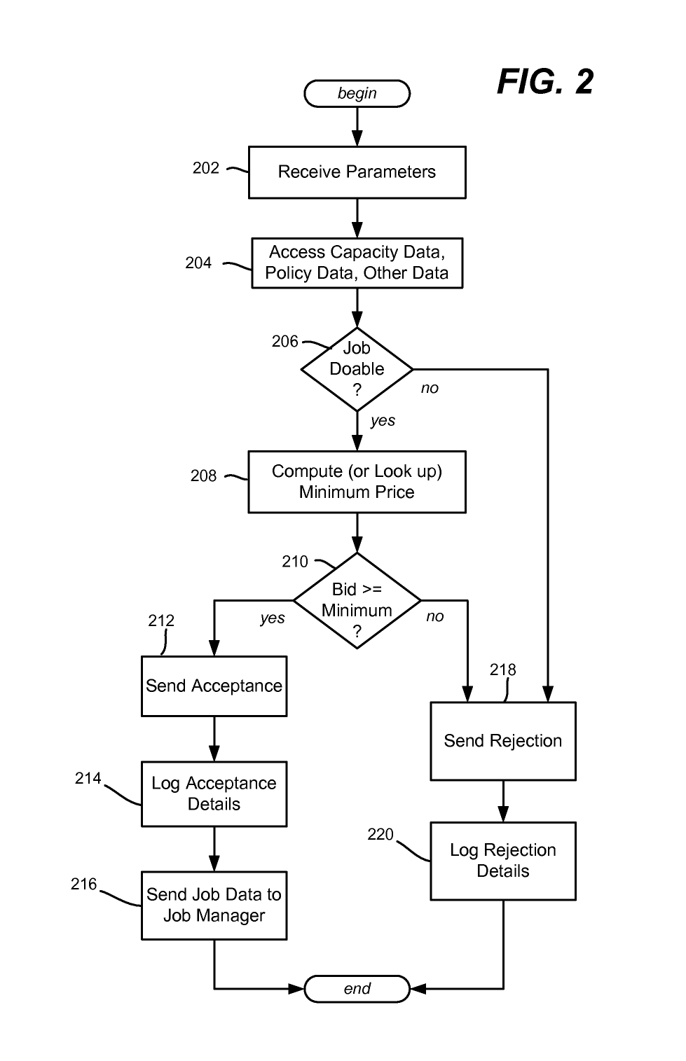

FIG. 2 is a flow diagram comprising example steps directed towards performance-based pricing in a bid scenario. In general, at step 202 a client submits a bid along with the batch application-related or interactive-related parameters (dimensions). As represented by step 204, the bid manager accesses capacity data, policy data and other data.

Step 206 represents evaluating the capacity data to determine whether the job is doable. As mentioned above, there may not be sufficient resources to complete the job in time. A client may be “blacklisted” such as for non-payment, which may be considered a job that cannot be done, (or alternatively the minimum acceptable bid may be infinite). If not doable, step 206 branches to step 218 which sends a rejection response, e.g., including a reason for the rejection, after which step 220 logs the details of the failed bid, such as for historical/trend data collection for subsequent analysis or use.

If the job is doable, step 208 computes a minimum price based upon the parameters, the current pricing policy and other data, e.g., the client profile. Note that instead of a computation, the minimum price may be looked up in the current pricing policy, such as if the bid fits within a standard class of bids.

Step 210 evaluates the computed price against the bid amount. If the bid is met, step 212 sends an acceptance response; for example, a copy of the terms (agreed upon in advance) may be sent as an acceptance response/a confirmation. The acceptance details may be logged (step 214) such as for historical/trend data collection for subsequent analysis or use. Step 216 represents sending the accepted job details to the job manager. Note that concepts such a credit check may be handled before or as part of acceptance into a binding agreement.

If not met, a rejection response is sent at step 218, providing whatever information the cloud service desires. A rejection in the form of counteroffer may be sent, such as if the bid is just short of the minimum. Step 220 logs the details of the failed bid, such as for historical/trend data collection for subsequent analysis or use. Another reason for logging the details is to prevent a client from incrementally bidding, as described above.

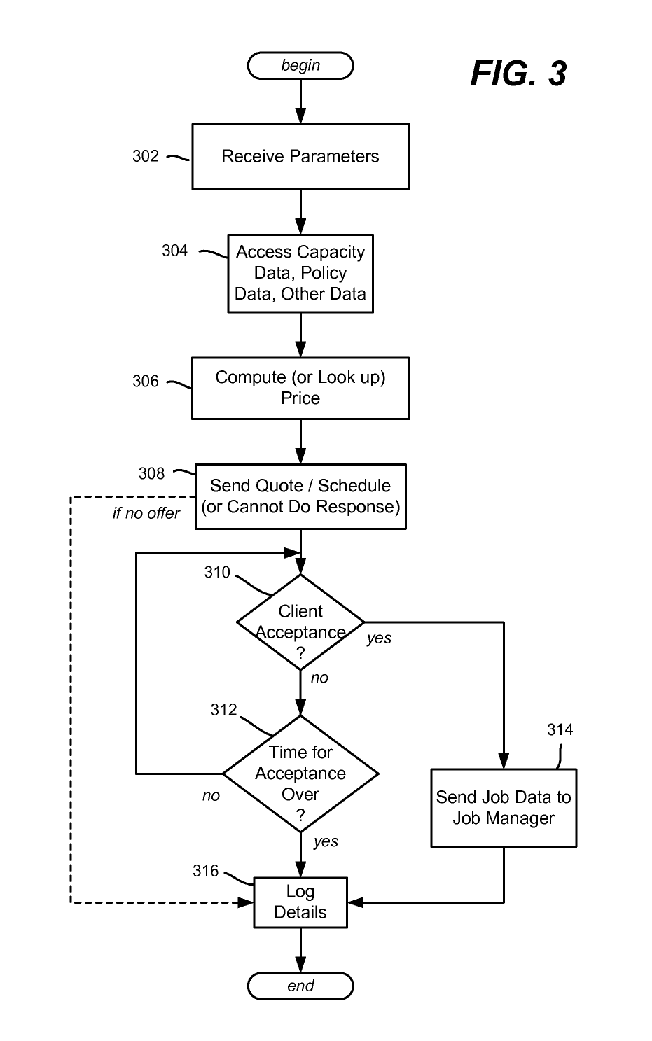

FIG. 3 is a flow diagram comprising example steps directed towards performance-based pricing in a price quote scenario, beginning at step 302 where the parameters are received at the price manager. As represented by step 304, the price manager accesses capacity data, policy data and other data, and uses this data to compute a price quote (which instead may be looked up in some situations).

Step 308 represents sending a price quote in a response, which may be binding if accepted in a certain timeframe. The quote may be in the form of a single price for a job, or schedule of prices, such as one for the quoted job plus quoted advertisements to let a client know of bulk discounts and prices incentives for a longer deadline. Step 308 also represents a response other than a binding quote, such as unable to meet the job parameters, a payment overdue notice, and so forth, possibly along with advertisements or alternative suggestions, e.g., cannot complete by 4 pm but can complete by midnight (for X price). A suggestion may or may not be a binding offer depending on how the service identifies the suggestion.

Steps 310 and 312 represent waiting for the client to accept. If accepted, step 310 branches to step 314 where data regarding the job data is sent to the job manager, with the acceptance-related details logged at step 316 for use as desired by the service. If not accepted before the acceptance time expires, step 312 branches to step 316 where the details of the non-acceptance are logged.

Note that during execution, the cloud service may verify whether performance, corresponding to the performance-related parameters specifying performance, is being met or not. For example, the cloud service may allocate more resources if the cloud service is responsible for meeting performance and is not. For example, for a batch job set, the service may perform verifying of units of work performed per time period (e.g., transactions per second), or for an interactive job, verifying service level agreement components based upon a combination of execution time and minimum throughput.

As can be seen, with a performance-based pricing scheme as exemplified herein, the user pays for desired performance, which corresponds to customers' desires for guarantees on performance (e.g., whether most users getting search results within 300 ms, whether a batch job will finish by a needed time). Performance-based pricing is also likely less expensive for jobs that can tolerate some delay before completion. Performance-based pricing allows cloud service provides to reduce load spikes by incentivizing customers to spread their loads over time. A contract between cloud and applications to meet these performance bounds provides certainty as to timing and cost.

### Example Operating Environment

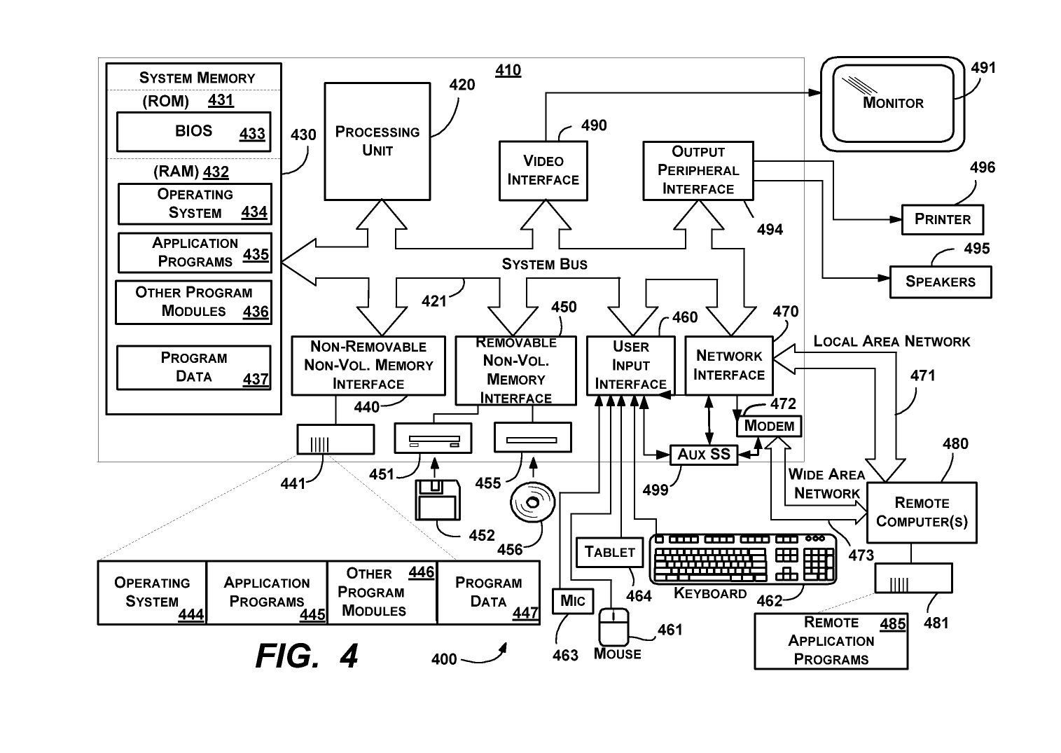

FIG. 4 illustrates an example of a suitable computing and networking environment 400 into which the examples and implementations of any of FIGS. 1-4 may be implemented, for example. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the example operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an example system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are examples and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising, receiving performance-related parameters specifying performance by a cloud service with respect to executing a job set comprising one or more jobs, and processing the performance-related parameters in determining a price for executing the job set.

2. The method of claim 1 wherein processing the performance-related parameters in determining the price comprises determining a minimum bid price, and further comprising, receiving a bid price as a parameter and returning a response corresponding to acceptance or rejection of the bid based upon an evaluation of the bid price against the minimum bid price.

3. The method of claim 2 wherein returning the response comprises returning a rejection comprising a counteroffer.

4. The method of claim 1 wherein processing the performance-related parameters in determining the price comprises maximizing revenue, computing social welfare, reducing operation costs or obtaining high resource utilization, or any combination of maximizing revenue, computing social welfare, reducing operation costs or obtaining high resource utilization.

5. The method of claim 1 further comprising, returning the price as part of a binding quote, or returning the price as part of a plurality of price data.

6. The method of claim 1 further comprising returning the price as part of a binding quote, and receiving an acceptance that corresponds to entering into a binding agreement.

7. The method of claim 1 further comprising, associating the job set with a penalty for not meeting the performance-related parameters with respect to executing the job set.

8. The method of claim 1 further comprising, verifying whether performance, corresponding to the performance-related parameters specifying performance, is being met or not.

9. The method of claim 8 wherein verifying whether the performance is being met or not comprises, for a batch job set, verifying units of work performed per time period, or for an interactive job, verifying service level agreement components based upon a combination of execution time and minimum throughput.

10. The method of claim 1 wherein the job set comprises a batch-type application, and wherein processing the performance-related parameters comprises processing a work volume parameter and time data comprising a completion time.

11. The method of claim 10 wherein processing the performance-related parameters further comprises processing a machine class parameter, a CPU parameter, a memory parameter, a storage parameter or one or more network-related parameters, or any combination of a machine class parameter, a CPU parameter, a memory parameter, a storage parameter or one or more network-related parameters.

12. The method of claim 10 wherein processing the performance-related parameters comprises further processing a datacenter parameter.

13. The method of claim 1 wherein the job set comprises an interactive-type application, and wherein processing the performance-related parameters comprises processing at least one of: an acceptance rate parameter, one or more capacity parameters each corresponding to statistical metric, or a time window parameter over which load is specified.

14. The method of claim 13 wherein one or more of the parameters are incorporated into a service level agreement, and further comprising, associating the interactive-type application with a penalty for any SLA violation.

15. The method of claim 1 wherein the job set comprises an interactive-type application, and wherein processing the performance-related parameters comprises processing one or more capacity parameters each corresponding to statistical metric, including at least one of: a minimum load, a maximum latency, a percentile load, or a percentile latency.

16. The method of claim 1 wherein determining the price comprises computing the price, and further comprising accessing capacity data for use in computing the price, accessing policy data for use in computing the price or accessing other data for use in computing the price, or any combination of accessing capacity data, policy data or other data for use in computing the price.

17. A system comprising, a cloud service associated with a manager, the manager configured to determine a price for execution of a job set by the cloud service, in which the price is determined according to performance-related parameters that specify a performance requirement, the manager further configured to return the price to a requesting client, or to evaluate a bid that includes a bid price against the price determined by the manager to decide whether to accept or reject the bid.

18. The system of claim 17 wherein the performance-related parameters comprise a work volume parameter, a parallelism parameter, or time data comprising a completion time, or any combination of a work volume parameter, a parallelism parameter, or time data comprising a completion time.

19. The system of claim 17 wherein the performance-related parameters comprise at least one of: an acceptance rate parameter, one or more statistical metric parameters, or a time window parameter over which load is specified.

20. One or more computer-readable media having computer-executable instructions, which when executed perform steps, comprising, entering, with a client, a performance agreement for executing a job set in a cloud service according to agreed-upon performance parameters and an agreed upon price, attempting to execute the job set according to the agreed-upon performance parameters, and compensating the client if unable to execute the job set according to the agreed-upon performance parameters.
